(19) United States
(12) Patent Application Publication
(10) Pub. No.: US 2010/0153296 A1
(43) Pub. Date: Jun. 17, 2010

(54) Method of administering an investment fund providing a targeted payout schedule

(76) Inventors: Kenneth E. Volpert, St. Davids, PA (US); Glenn Booraem, Chester Springs, PA (US); Bert S. Dalby, Wayne, PA (US); John E. Buhl, Wayne, PA (US)

Correspondence Address: RATNERPRESTIA, P.O. BOX 1596, WILMINGTON, DE, 19899, US

(21) Appl. No.: 11/702,281

(22) Filed: Feb. 5, 2007

(51) Int. Cl. G06Q 40/00

(52) U.S. Cl. 705/36 R

(57) ABSTRACT

An investment fund that offers shares to investors, which shares provide to their holders a predictable stream of payments over some period. Each payment in the stream of payments is scheduled to be made according to a targeted payment schedule that is established by the investment fund at the time of its creation. The investment fund receives purchase requests and funds from interested investors and invests the funds in securities that provide payments that are used to meet or approximate the targeted payment schedule. A preferred form of the investment fund invests the received funds in Treasuries whose interest or coupon payments and/or principal payments or maturities approximately map to the targeted payment schedule. Principal (or maturity) and interest (or coupon) payments made by the Treasuries are used to provide payments to the investors when such payments become due according to the targeted payment schedule.

### FIELD OF THE INVENTION

The present invention relates, in general, to a method of administering an investment company or trust fund (herein collectively referred to as an “investment fund”). More specifically, the present invention relates to a method of providing one or more classes of shares of an open-end investment company (commonly called a “mutual fund”), each class having a targeted payout schedule which specifies payments to be made to investors over a scheduled life of the investment company.

### BACKGROUND OF THE INVENTION

It is understood in the investment industry that investors of different ages generally possess different risk preferences. Younger workers whose time horizon is much longer than workers approaching retirement may assume more risk in their investment portfolios. The higher risks provided by such portfolios over the short term are mitigated by the long-term positive trend in such portfolios.

As workers approach retirement, their risk preferences typically change to a more conservative profile, and they usually become less willing to assume risk. Those who have already entered retirement may have even less desire to take investment risks. Short-term losses are not as tolerated because retirees often cannot wait for the value of their portfolios to rebound.

Further constraining older investors' or retirees' investment decisions is their need or preference for investments that generate a reliable stream of payments to meet monthly (or other) expenses and discretionary expenditures. Without steady wages provided by employment, older investors and retirees often look to their investments to provide their needed income or cash flow. Investment vehicles that provide a steady (or nearly steady) stream of payments are usually preferred for peace of mind and to virtually ensure the ability to pay for food, shelter, medical bills, vacations, etc. Thus, older investors and retirees generally prefer investment vehicles that provide known (or reasonably knowable) streams of payments and that carry low risks of default.

Outside of defined benefit plans and defined contribution plans, which are tied to employment, there are many lower-risk investment options that are available to provide income streams to retirees. As discussed below, each of these investment options suffers from drawbacks.

One such option is a deferred annuity contract which is typically sold in exchange for a lump sum premium, possibly with a contract to make additional payments until retirement. Annuities typically grow at a variable rate (sometimes with a partial guarantee of the rate) until retirement and usually make payments for a single life, joint life, or for a period certain.

Annuity contracts suffer from several significant disadvantages. The fact that an annuity contract provides payments for the life of the contracting party (or joint lives of the contracting parties) is, potentially, a disadvantage if the death of a party ceases the annuity payments well before much of the value of the annuity has been recouped. Annuity contracts are typically complex and hard to understand, making adequate investment decisions for retirement difficult for most investors. Annuity contracts carry high fees and expenses, when compared to the fees and expenses of mutual funds. Finally, annuity contracts are generally illiquid and may only be exchanged for a sum which is aptly named the contract's “surrender value.”

In addition, annuity contracts may not be as favorable from an estate planning perspective as other types of investments. If a beneficiary is entitled to receive a benefit from the annuity, the value of that benefit could be subject to estate taxes. Whether or not subject to estate taxes, the benefit will be subject to income tax rules that are less favorable than those available for other investments. For instance, taxable investments, including open-end mutual fund shares, are eligible for a basis adjustment upon the death of the owner, under current law. If the investments have appreciated during the owner's lifetime, the beneficiaries will inherit them with an income tax basis that is “stepped up” to then fair market value. When the investment is sold or exchanged by the beneficiary, the beneficiary will owe capital gains tax only on the appreciation during the time the beneficiary owned the investment—not on the growth during the original owner's lifetime. Annuities, on the other hand, are not eligible for this benefit and, indeed, are inherited along with the owner's tax bill for those assets. As they take distributions, the beneficiaries will be liable for the ordinary income taxes on the amounts in these accounts that were never taxed during the owner's lifetime.

Another option is an income-oriented mutual fund that invests primarily in bonds or other types of debt securities. Income-oriented mutual funds provide payments to shareholders that usually consist only of interest payments derived from the underlying debt securities and do not include a systematic return of principal/investment portion. This results in relatively smaller payments to investors, because there is no return of the principal portion over the life of the investment. Other disadvantages of income-oriented funds stem from the “prepayment risk” or “call risk,” which is the risk that the issuers of the bonds owned by the fund will prepay them at a time when interest rates have declined, and the “reinvestment risk,” which is the risk that debt securities that mature may need to be reinvested in a market environment of lower yields. As a result of the prepayment risk and reinvestment risk, an income-oriented mutual fund cannot promise to generate a predictable stream of payments to a shareholder. Thus, payments may vary.

Yet another option is a closed-end investment company that is structured to produce a targeted level, or percentage rate, of distributions. These so-called “managed distribution funds” typically invest in stocks or high yield bonds and seek to provide a sustained, but not guaranteed, level of monthly or quarterly distributions. Distributions by these managed distribution funds include a combination of interest income, return of capital, and capital gains. These managed distribution funds offer investors the opportunity to participate in balanced (i.e., from stocks and bonds) returns while enjoying a predictable (but low) cash flow. One disadvantage of managed distribution funds is the fact that they pay out a relatively low target cash flow due to the uncertainty surrounding the expected future returns of the balanced portfolio. Another disadvantage of managed distribution funds is that, as closed-end funds, they do not continuously offer shares for sale to investors after the initial public offering of the fund.

Accordingly, there is a need for an investment fund that provides a predictable stream of payments over the life of the investment fund and that avoids one or more of the deficiencies prevalent in the existing selection of investment options.

### SUMMARY OF THE INVENTION

One aspect of the present invention comprises a method of administering an investment fund having a scheduled liquidation date. The method comprises creating one or more classes of shares, continuously offering a plurality of shares for sale in each of the one or more classes of shares until the liquidation date, determining per each share in the one or more classes of shares a targeted payment schedule that specifies payments to be made until the liquidation date of the investment fund, issuing at least one share to an investor in exchange for funds received from the investor, investing the received funds in a pool of underlying securities, and providing payments to the investors according to the targeted payment schedule corresponding to the at least one issued shares. The underlying securities, in aggregate, provide scheduled payments that finance the payments provided to each investor according to the targeted payment schedule. The underlying securities are is selected such that their scheduled payments approximately map to the payments specified by the targeted payment schedule corresponding to the at least one share. The targeted payment schedule may provide for payments to be made to investors (i) in approximately equal amounts, (ii) in amounts that grow over time (for example, to account for anticipated inflation), or (iii) in amounts that change based upon some predetermined schedule, methodology, or formula. The targeted payment schedule provides for the payments to be made until the liquidation date of the investment fund.

The underlying securities may be debt securities which provide principal (or maturity) payments and interest (or coupon) payments to the investment fund. The debt securities may include, for example, (i) conventional bonds that usually make regular interest payments before maturity and a principal payment at maturity, (ii) zero coupon bonds that usually make a single payment at maturity, (iii) inflation-indexed securities, or (iv) mortgage-backed securities or asset-backed securities. Generally, the interest (or coupon) and principal (or maturity) cash flows from the underlying debt securities are used to make the payments to investors according to the targeted payment schedule for each of the one or more issued shares. A portion of the payments made according to the targeted payment schedule is sourced from the interest payments earned from the underlying debt securities and a portion is sourced from maturing debt securities.

With respect to the tax treatment of payments to investors, in the early time period of the fund, most of the scheduled payments to the investors will be taxable income generated by the underlying debt securities and, over time, a greater portion of the scheduled payments to the investors will be return of capital. By the liquidation date of the investment fund, all capital is returned. Generally, distributions by the investment fund may include income, return of capital, and capital gains.

To be clear, the present invention is not limited to embodiments in which the underlying securities are debt securities, nor is it limited to any specific legal structure for an investment fund. The underlying securities may include any kind of security that provides an income stream that approximately maps to the targeted payment schedule. The investment fund may take on any legal structure, including an open-end investment company, a unit investment trust, a common trust fund, or a comingled trust fund (also called a “collective trust fund”), that issues shares, units, beneficial interests, or positions to interested investors on a continuous basis up until the scheduled liquidation date of the investment fund.

Further, it is understood that, although a preferred embodiment of the present invention involves a shift over time from most of the predetermined payments being sourced from interest (or coupon) payments to being sourced from principal (or maturity) payments, the present invention is not limited to that construct, and such payments could be sourced from any mix of interest and/or principal payments. Likewise, it is understood that from a tax treatment perspective, although a preferred embodiment of the present invention involves a shift over time from most of the predetermined payments being treated as taxable income to being treated as return of capital, the present invention is not limited to that construct, and such payments could be treated as any mix of taxable income and return of capital.

The targeted payment schedule may provide for estimated periodic payments to the investor and the underlying securities may be debt securities that provide principal and interest payments to the investment fund. In this case, the investment fund selectively invests the received capital in the debt securities so that the principal and interest payments made by the debt securities approximately map to the targeted payment schedule. Treasury STRIPs (“Separate Trading of Registered Interest and Principal of Securities”), whose maturities correspond to the estimated periodic payments, may be used as underlying investments to fund the targeted payment schedule.

The investment fund may be designed to hold total assets that exceed the total amount needed to satisfy the targeted payment schedule (plus fees and expenses of the investment fund). Doing so improves the payment certainty of the targeted payment schedule. These excess assets can help absorb unexpected expenses or costs of the investment fund which, if not accounted for, might reduce the actual stream of payments to investors to amounts below the targeted payment schedule. The unused portion of the excess assets is reflected in the net assets of the investment fund and is owned proportionately by each investor in the investment fund. An investor receives his share of any unused portion of the excess assets when the investment fund makes its final payment (i.e., upon the liquidation date of the investment fund) or earlier if the investor redeems his investment before the is liquidation date. An investor could also receive his share of any unused excess assets if the investment fund makes an unscheduled distribution prior to the liquidation date of the investment fund. The investment fund may also impose a redemption fee (or similar fee). The proceeds of the redemption fee would be held within the investment fund and be proportionately owned by all investors. These proceeds could also be considered part of the excess assets described above.

Another aspect of the present invention comprises an embodiment of a method of administering an open-end investment company comprising one or more classes of shares and a scheduled liquidation date. The method comprises the steps of offering a plurality of shares of an open-end investment company in any of the one or more classes of shares for sale, determining a targeted payment schedule for each of the plurality of shares, issuing at least one share to an investor in exchange for funds received from the investor, investing the received funds in one or more securities that provide scheduled payments that approximately map to the payments specified by the targeted payment schedule corresponding to the at least one share, issuing the at least one share to the investor, and providing payments to the investor according to the targeted payment schedule. The plurality of shares are offered for sale on a continuous basis beginning with a time when the plurality of shares are first offered for sale and lasting until the scheduled liquidation date of the investment company.

Yet another aspect of the present invention comprises an embodiment of a method of administering a common trust fund, a collective trust fund, or a comingled trust fund comprising a scheduled liquidation date. The method comprises the steps of offering a plurality of shares for sale on a continuous basis from a time when the plurality of shares are first offered for sale until the scheduled liquidation date, determining a targeted payment schedule for each of the plurality of shares, issuing at least one share to an investor in exchange for funds received from the investor, investing the received funds in one or more securities that provide scheduled payments that approximately map to the payments specified by the targeted payment schedule, and providing payments to the investor according to the targeted payment schedule.

Still another aspect of the present invention comprises an embodiment of a method of administering a unit investment trust comprising a scheduled liquidation date. The method comprises the steps of offering a plurality of units for is sale on a continuous basis from a time when the plurality of units are first offered for sale until the scheduled liquidation date, determining a targeted payment schedule for each of the plurality of units, issuing at least one unit of the unit investment trust to an investor in exchange for funds received from the investor, investing the received funds in one or more securities that provide scheduled payments that approximately map to the payments specified by the targeted payment schedule for each issued unit, and providing payments to the investor according to the targeted payment schedule. The targeted payment schedule specifies payments to be made by the unit investment trust for each unit until the scheduled liquidation date of the unit investment trust and provides for payments to be made for each unit with a recurring predetermined time interval between payments. A first payment according to the targeted payment schedule is provided within a period of time equal to two predetermined time intervals after the step of issuing of the plurality of units.

Thus, one or more embodiments of the invention comprise an investment fund that continuously offers and issues shares, units, beneficial interests, or positions that provide a scheduled and predictable stream of principal and/or interest payments over the life of the investment fund and that are redeemable or may be sold on an exchange. The investment fund purchases securities whose aggregate payment stream (e.g., coupon and maturity payments) closely tracks a predictable, or targeted, payment schedule. Such an investment fund is, in essence, an annuitizing mutual fund which enables an investor to convert a lump sum payment into a stable stream of periodic (e.g. monthly) payments over a period of years, while providing optional daily redemptions at net asset value and favorable estate planning treatment.

### BRIEF DESCRIPTION OF THE DRAWINGS

The invention is best understood from the following detailed description when read in connection with the accompanying drawings. Included in the drawings are the following figures:

FIG. 1 is an illustration of an open-end investment company (mutual fund) comprising a pool of underlying securities, in accordance with an embodiment of the present invention;

FIG. 2 is flow diagram of a method of administering the open-end investment company (mutual fund) of FIG. 1 to provide scheduled streams of payments to fund investors, in accordance with an embodiment of the present invention;

FIG. 3A is a chart of net cash flows to an investor in an exemplary embodiment of the fund of FIG. 1 having a 5-year life;

FIG. 3B is a chart of yearly cash flows of the exemplary embodiment of the fund of FIG. 1 having the 5-year life;

FIG. 4 is a chart illustrating constant monthly cash flows of an exemplary embodiment of the fund of FIG. 1 having a 30-year life; and

FIG. 5 is a chart illustrating increasing monthly cash flows of an exemplary embodiment of the fund of FIG. 1 having a 30-year life.

### DETAILED DESCRIPTION OF THE INVENTION

The present invention is described below in the context of an investment fund or vehicle comprising a pool of underlying securities. The invention is not limited to one type of underlying security, nor is it necessarily limited to debt securities or securities having debt security-like characteristics. Accordingly, where the context permits, the term “underlying security” includes any financial instrument, such as a debt security, that represents a payment given by an investor to an issuer in return for future payments by the issuer. For reasons described below, it is preferred that the underlying security be a financial instrument that provides a predictable payment or stream of payments (in both time and amount) to the owning investor. Where used, the term “debt security” includes a financial instrument that represents a payment given by an investor to an issuer in return for a promise by the issuer to pay interest and to repay the investment on a specified date. Examples of debt securities include Treasury bills, Treasury notes, Treasury bonds, Treasury Inflation-Protected Securities, other inflation-protected securities, zero-coupon Treasury securities (also referred to herein as “Treasury STRIPs”), corporate debt securities, municipal bonds, mortgage-backed securities, asset-backed securities, collateralized debt obligations, collateralized loan obligations, interests in bank loans, and other securities that provide payments, such as fixed income securities. It is also contemplated that, where appropriate, “underlying securities” may also include credit-default swaps, interest rate swaps, total return swaps, and other derivatives.

As used herein, the term “investment fund” refers to a legal entity that issues shares, units, beneficial interests, or positions to interested investors on a continuous basis. The term “investment fund” includes open-end investment companies (mutual funds), unit investment trusts (“UITs”), and trust funds, as those terms are understood in the art. Examples of trust funds include, without limitation, common trust funds, comingled trust funds, and collective trust funds. For brevity, shares (such as conventional shares and exchange-traded shares), units, beneficial interests, and positions in investment funds are referred to herein simply as “shares,” where the context permits.

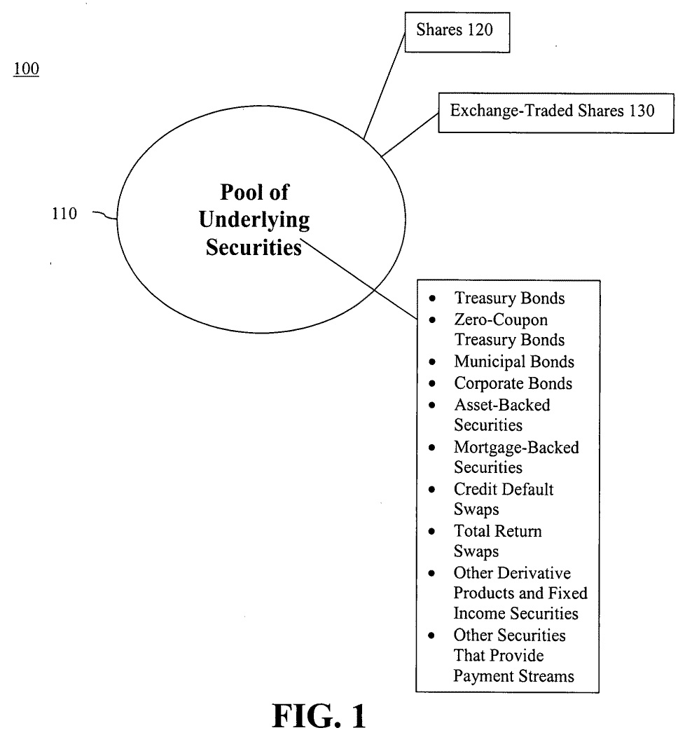

Referring now to FIG. 1, there is illustrated an open-end investment company (mutual fund) 100 (herein “fund 100”) in accordance with an exemplary embodiment of the present invention. Exemplary fund 100 includes a pool of underlying securities 110 and one or more classes of shares, namely a class of conventional shares 120, which are priced once per day at their net asset value (herein “NAV”), and a class of exchange-traded shares 130, which are priced throughout the day depending on market factors. Details associated with an investment company that issues a class of conventional shares and a class of exchange-traded shares in the same fund are provided in U.S. Pat. No. 6,879,964, issued on Apr. 12, 2005, naming a common assignee of the present invention, and incorporated herein by reference.

It is noted that although the exemplary embodiment illustrated in FIG. 1 shows a number of different classes of shares, specifically a class of conventional shares 120 and a class of exchange-traded shares 130, embodiments having a different number of classes of shares in any combination (including multiple conventional share classes and exchange-traded share classes) may also be provided, including but not limited to embodiments comprising only one or more classes of conventional shares and embodiments comprising only one or more classes of exchange-traded shares.

In the exemplary embodiment illustrated in FIG. 1, fund 100 is an open-end investment company (mutual fund) and, therefore, at any time prior to the scheduled liquidation date of fund 100, offers conventional shares 120 for sale. Additionally, because fund 100 is a mutual fund, investors may redeem their shares at any time at their NAV. Fund 100 offers exchange-traded shares 130 to investors in blocks called “creation units” at any time prior to the liquidation date of fund 100. The investors in creation units may then break up the blocks of shares and sell them on a secondary market to other investors.

It is understood that the embodiment of fund 100 as a mutual fund is intended as a non-limiting example. Fund 100 may be embodied as any kind of investment fund, as that term is defined above. Thus, for example, in another exemplary embodiment, fund 100 may be a trust fund, such as a common trust fund or a comingled trust fund (also called a collective trust fund). In yet another exemplary embodiment, fund 100 may be a UIT. It is appreciated that the descriptions herein of fund 100 and the method 200 of administering fund 100 are applicable to the exemplary embodiments of fund 100 in which fund 100 is any of the above-mentioned trust funds or the UIT, with appropriate modifications. In embodiments in which fund 100 is a trust fund, shares in fund 100 are sometimes referred to as units or beneficial interests. In embodiments in which fund 100 is a UIT, shares in fund 100 are sometimes referred to as units.

A comingled trust fund (also called a collective trust fund) is generally understood as a pooled investment vehicle, maintained by a bank or trust company.

Participation in such a trust fund may be limited to certain types of participants, such as certain types of tax exempt employees, participants in profit-sharing plans, or participants in other qualified retirement plans such as pension plans or vehicles holding retirement plan assets. A common trust fund is generally understood as a trust fund in which funds of many persons are comingled for purposes of economy of administration and counseling and for which a bank or other financial institution is trustee.

At the time of creation of fund 100, fund 100 is established to have a scheduled life or liquidation date, and each share in each class of shares 120 and 130 is established to have a targeted payout schedule that spans the life of fund 100. A “targeted payout schedule” or “targeted payment schedule” describes the stream of payments that an investor of a share in fund 100 may expect to receive over the life of fund 100. The targeted payment schedule also describes when the investor may expect to receive each of the payments. The classes of shares of fund 100 may have identical targeted payment schedules, but it is also contemplated that they may be different. Thus, the targeted payment schedule for one class of shares may differ from the targeted payment schedule for another class of shares in the frequency, number, and/or size of the payments.

The payout or payment schedule is described as “targeted” or “scheduled” because the actual stream of payments distributed by fund 100 is not backed by a guarantee, credit facility, or other financial support and, therefore, could be different from the expected stream of payments. As discussed below, fund 100 may take steps to minimize its risk exposure to thereby provide to investors confidence in the targeted payment schedule. In alternative embodiments, fund 100, however, could guarantee each of the payments, in both time and amount, in the targeted payment schedule.

The targeted payment schedule provides that the payments begin after the creation of fund 100 and are made periodically or at regular intervals or times until fund 100 is liquidated. Each of the payments made by fund 100 to an investor is expected to be sourced from interest (or coupon) and principal (or maturity) payments of the underlying securities 110, and to comprise taxable income and return of capital portions (the capital being the initial investment of the investor in fund 100). It is understood that the interest and principal portions are also, respectively, known as dividends and return of capital portions. (Fund 100 is intended to qualify as a regulated investment company (RIC) for U.S. tax purposes. Provided that fund 100 distributes all portfolio income and gains to investors each calendar year, no tax generally will be paid by fund 100 at the entity level, under current U.S. law. Rather, investors in fund 100 will pay any tax due on such income and gains. Notwithstanding this treatment of fund 100 as an RIC for U.S. tax purposes, fund 100 is described herein using standard economic terms known in the art. For example, references to “excess cash flow” and “excess assets” herein do not preclude fund 100 from making all current income distributions to investors as required under U.S. tax rules that apply is to RICs.)

To meet the targeted payment schedule, fund 100 structures its investments in underlying securities 110 to provide a stream of payments to fund 100, which payments approximately map to the payments made to an investor according to the targeted payment schedule. It should be understood that structuring the investment in underlying securities 110 to approximately map to and fund the payments made according to the targeted payment schedule allows fund 100 to operate without taking out lines of credit, or similar credit facilities or loans, to fund the payments. Therefore, fund 100 operates without the added costs associated with taking out lines of credit or similar credit facilities or loans. Illustrated in FIG. 1 is a list of securities which may be included in underlying securities 110. This list of securities includes treasury bonds, zero-coupon treasury bonds, municipal bonds, corporate bonds, asset-backed securities, mortgage-backed securities, credit default swaps, total return swaps, any other derivative products and fixed income securities, and any other securities that provide payments.

In embodiments of fund 100 in which underlying securities 110 are debt securities, each payment provided by underlying securities 110 to fund 100 is expected to comprise interest (or coupon) and/or principal (or maturity) payments and may include capital gains arising from turnover in the underlying portfolio of debt securities. In an exemplary embodiment, the total value of underlying securities 110 exceeds the total amount needed to satisfy the targeted payment schedule (plus fees and expenses of fund 100) in order to help absorb unexpected expenses or costs that might reduce the actual stream of payments to an amount below the scheduled stream of payments.

In one embodiment of fund 100, the amount of each payment in the targeted payment schedule is equal, i.e. constant, over the life of fund 100. In another embodiment, the amount of each payment increases by a fixed currency amount, e.g. fixed number of dollars, or by a fixed percentage from payment to payment. In other words, each payment is greater than a previous payment by a fixed amount of currency (dollars) or by a fixed percentage. As a non-limiting example, in the case of a fixed percentage, the payments may increase by 3% or 5% from payment to payment or on a year-to-year basis. In yet another embodiment of fund 100, the payments are tied to a consumer price index or similar measure such is that payments vary as inflation varies. For purposes of discussion below, such a fund is referred to as “inflation-adjusted” or “inflation-compensated.” In another non-limiting example, fund 100's stream of payments could change based upon a predetermined schedule, methodology, or formula that meets the specialized cash flow needs of a group or segment of investors. Such a schedule may follow an index or floating rate, such as the federal funds rate, the yield on a 15-year Treasury, etc. Thus, the actual value of each periodic payment may be determined using a predetermined formula that is based upon the corresponding value of a predetermined variable, such as an index or floating rate, at a predetermined time prior to the scheduled date of the payment.

As mentioned above, at creation, fund 100 is established to have a scheduled life or liquidation date. For example, fund 100 may have a scheduled life of 5 years, meaning that fund 100 establishes a targeted payment schedule that provides a stream of payments to owners of shares 120 and 130 over the 5-year life of fund 100, ending at the liquidation date. Alternatively, fund 100 may have a scheduled life of 10, 15, or 30 years or any duration that the charter of fund 100 designates.

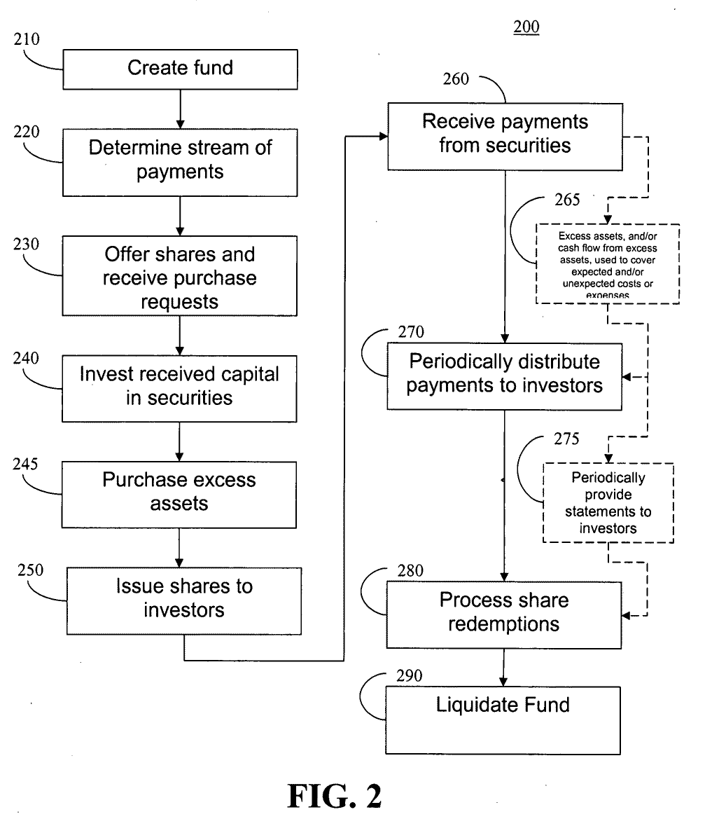

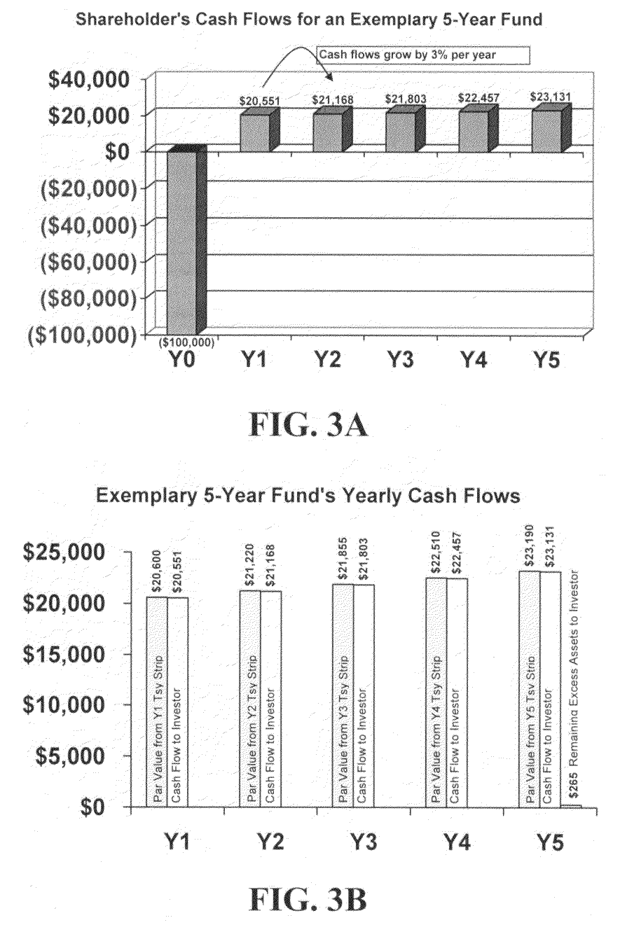

During the life of fund 100, fund 100 continuously offers shares 120 and 130 for sale to investors. In doing so, fund 100 is not limited to offering shares for sale at a one time event, such as at an initial public offering, but instead keeps its offer to issue and sell shares open for the entire life of the fund up until the scheduled liquidation date. Up until the scheduled liquidation date, fund 100 receives and processes purchase requests from interested investors (purchasers) who provide cash to fund 100 in exchange for shares. Fund 100 then invests the cash it receives in securities for inclusion in the pool of underlying securities 110. In an exemplary embodiment, investors provide (and fund 100 accepts) securities, which are pooled into underlying securities 110, in exchange for shares. Such an exchange of securities for shares is commonly understood as an “in-kind exchange.” Fund 100 may be structured to allow for either cash purchase of shares or in-kind exchanges, or a mixture of both. Fund 100's investment in underlying securities 110 is described in more detail below in FIG. 2 and in the examples illustrated in FIGS. 3-5.

In the exemplary embodiment of fund 100 that includes excess assets as described above, fund 100 purchases more of underlying securities 110 than is required such that the cash flow produced by such excess underlying securities is exceeds the amount needed to satisfy the targeted payment schedule. Such excess assets are expected to generate cash flow to fund 100 over time. Fund 100 uses these excess assets, and/or cash flow from such excess assets, to pay administrative costs and to help absorb unexpected expenses or costs that might reduce the actual stream of payments below the amount of the scheduled stream of payments. Additionally or in the alternative, each time fund 100 provides a payment to the investor according to the targeted payment schedule, fund 100 may allocate any excess cash flow into the excess assets. In an exemplary embodiment, fund 100 also uses the excess assets to act as a cushion between incoming payments to fund 100 from securities 110 and outgoing payments to the owners of shares 120. This cushion may be needed when the incoming and outgoing payments do not occur at the same time. After the life of fund 100 ends, fund 100 is liquidated. Creation and liquidation of fund 100 is discussed in greater detail below in relation to FIG. 2.

FIG. 2 illustrates a method 200 of administering fund 100 in accordance with an exemplary embodiment of the present invention. It should be noted that although the method is described herein with respect to fund 100, which has a class of conventional shares 120 and a class of exchange-traded shares 130, alternative methods, with corresponding steps as appropriate, may also be performed for funds having only a single class of shares (conventional or exchange-traded) as well as for funds with more than two classes of shares (conventional or exchange-traded or some mixture of both). Accordingly, method 200 is intended to be a non-limiting example only.

At step 210, fund 100 determines the scheduled liquidation date. Therefore, in step 210, the issue price of each share in each class of shares 120 and 130 is also established. From then on, because shares 120 are conventional shares, they are priced daily at their net asset value or NAV. Exchange-traded shares 130, on the other hand, once they are out in the open market, are sold and resold—and thus valued and priced—throughout the day in the open market according to market forces.

At step 220, fund 100 determines the targeted payment schedule of shares 120 and 130. The determination of the targeted payment schedule involves determining the size of each of the payments in the stream of payments made by fund 100 for each of shares 120 and 130 and the timing of each of the payments. These determinations could be made taking market conditions (including, without limitation, current market yields for debt securities) into consideration.

Fund 100 sets the targeted payment schedule to provide periodic (or approximately periodic) payments to investors. In an exemplary embodiment, the targeted payment schedule is structured such that each time period between successive payments is equal, thus making the payments periodic. An example of such a schedule is one that provides payments weekly, every two weeks (“biweekly”), every three weeks, etc. In another exemplary embodiment, the targeted payment schedule is structured such that payments are nearly, but not precisely, periodic. In such a schedule, payments are made on the same day of every month (“monthly”), every other month (“bi-monthly”), every quarter (“quarterly”), every six months (“semi-annually”), every year (“yearly”), every two years (“biennially”), etc. (and may be subject to a convention that payments are provided on business days). It should also be understood that the term “approximately periodic” as used herein contains the universe of precisely periodic (weekly, biweekly, etc.) as well as nearly periodic (monthly, quarterly, etc.) schemes. It will be understood that fund 100 is not limited to providing only an approximately periodic payment schedule. Any scheduling convention is possible, as long as the schedule provides a targeted payment stream and is communicated to investors at the creation of fund 100. A regular payment schedule has the advantage of providing to investors an ability to expect when fund 100 will provide payments.

Fund 100 begins making payments for each share after the share is issued to a purchasing investor and continues making payments according to the targeted payment schedule until the liquidation date of fund 100. The first payment to an investor may be made in the first full period after which the share was issued, or it may be made on the next business day the regular payment is to be made. Fund 100 does not require an accumulation period before providing payments according to the targeted payment schedule. Therefore, fund 100 has the advantage of providing an investment vehicle in which investors may purchase shares that provide a reliable stream of payments that begin almost immediately after issuing. Another way of expressing this concept is to say that the targeted payment schedule provides for payments to be made to the investor with a recurring predetermined time interval between payments, having a first payment to the investor scheduled to be made within the first or second predetermined time interval immediately after the step of issuing of the plurality of shares. It should be noted that the “predetermined time interval” may be a precise period of time (4 weeks) or an approximate period of time (monthly). Thus, if payments are to be received at the end of each month, the investor receives a first payment at the end of the first month after investing. Of course, to allow time for processing, in some embodiments or situations, the payment may not be received until the second month after investing. It is understood, however, that fund 100 could begin making payments according to any schedule, regardless of whether such schedule includes having the payments begin within a period of time after issuance which is less than or equal to one predetermined interval of time, two predetermined intervals of time, etc.

At step 220, fund 100 also determines whether shares 120 and 130 of fund 100 are to provide a constant stream of payments, an increasing stream of payments, an inflation-adjusted stream of payments, or a stream of payments that could change based upon a predetermined schedule, methodology, or formula to meet the specialized cash flow needs or expectations of a group or segment of investors identified by fund 100. At step 230, fund 100 continuously offers shares for sale to interested purchasers (investors) and receives purchase requests from interested purchasers (investors) who provide fund 100 with capital in exchange for shares.

In an exemplary embodiment, fund 100 begins offering shares for sale in step 230 with a first offering and continues offering the shares for sale, i.e. fund 100 holds open the offer, until a predetermined end date, which may be the scheduled liquidation date of fund 100. In a further exemplary embodiment, fund 100 may accept purchase requests during a subscription period in which investors may seed capital to fund 100 before fund 100 is opened to the general public. By continuously offering shares for sale, fund 100 has the advantage of providing a flexible investment vehicle that allows investors to purchase into (and redeem out of) fund 100 at any time during the life of fund 100. It is understood that the other embodiments of fund 100 as any of the above-mentioned trust funds or the UIT may include this advantageous feature.

Continuing at step 240, at or about the time fund 100 receives the share purchase requests and capital from investors, fund 100 invests the received capital in securities to be added to the pool of underlying securities 110. Fund 100 structures its purchase of the underlying securities to obtain those that provide payments, such as principal and interest payments, that generally map to the targeted payment schedule established in step 220. At step 245, a portion of the received capital is used to purchase more of underlying securities 110 than is required such that the cash flow produced by such excess assets exceeds the amount needed to satisfy the targeted payment schedule. Fund 100 accumulates this excess cash flow and uses such excess assets, and/or the cash flow from such excess assets, to help absorb expected or unexpected expenses or costs that might reduce the actual stream of payments to investors below the amount of the scheduled stream of payments specified in the targeted payout schedule.

It is appreciated that, in the embodiment in which underlying securities 110 comprise debt securities, because the stream of payments paid by fund 100 according to the targeted payment schedule may extend over many months or years, fund 100 invests in debt securities having a plurality of maturities. This investment strategy provides for pool of underlying securities 110 to generate maturity payments to fund 100 over all or a portion of the lifespan of fund 100. Additionally, because underlying securities 110 may be coupon-paying debt securities, they may also generate coupon (or interest) payments over all or a portion of the lifespan of fund 100.

At step 250, fund 100 issues shares to the investors who submitted purchase requests in step 230. At step 260, fund 100 receives the payments made by underlying securities 110. At step 270, fund 100 uses the payments made by securities 110 to provide the streams of payments to the investors (i.e., the shareholder of record) according to the targeted payment schedule. Fund 100 also pays off any operating or administrative costs or expenses, expected or unexpected, in step 270. In embodiments of fund 100 in which underlying securities 110 include debt securities, the principal and interest payments provided by the debt securities are used to fund the payments provided to the investors according to the targeted payment schedule. If all or a portion of the investment portfolio of fund 100 is comprised of derivatives (such as total return swaps), then the payments received by fund 100 on account of such derivatives may or may not be characterized as principal payments or interest payments; nevertheless, fund 100 uses such derivative-based payments in the same manner as it uses principal payments or interest payments from debt securities.

Further with regard to step 270, in the context of exchange-traded shares 130, fund 100 will provide the streams of payments to the investor, namely the shareholder of record of such exchange-traded shares 130. Due to the fact that exchange-traded shares 130 are sold by fund 100 to investors (brokers) in blocks called “creation units,” which brokers then break up the blocks of shares and sell them on a secondary market to other investors, when fund 100 provides such streams of payments to the shareholder of record (i.e., the broker), that shareholder of record will, in turn, provide such streams to the ultimate investor according to methods known in the art.

Because fund 100 is an open-end fund, it offers owners of conventional shares 120 the ability to redeem such shares 120 at any time at NAV. At step 280, at any time prior to the liquidation date of fund 100, such owners may tender their conventional shares 120 back to fund 100 and receive from fund 100 an amount equal to the number of shares tendered multiplied by the next-calculated NAV, less any fees or expenses. Owners of exchange-traded shares 130 may sell their shares on appropriate exchanges at any time.

In the exemplary embodiment that includes excess assets, method 200 includes a step 265, in which fund 100 periodically uses a portion of the excess assets (i.e., an amount above that needed to make the targeted payments to investors), and/or the cash flow generated by such excess assets, to pay the expected and unexpected costs and expenses of fund 100.

It will be appreciated that fund 100 may not be able to purchase underlying securities 110 that provide payments, such as principal and interest payments in embodiments in which underlying securities 110 are debt securities, that exactly map, in time and in amount, to fund 100's targeted payment schedule. This might happen, for example, if fund 100 establishes a targeted payment schedule that provides monthly payments to investors but invests in debt securities that provide yearly coupon payments or that do not provide any coupon payments and mature at three-month or six-month intervals, as in the case of Treasury STRIPs. To deal with mismatch between the payments from securities 110 and the targeted payment schedule, in an exemplary embodiment at step 265, fund 100 retains the payments received by underlying securities 110 in step 260 as excess assets. At step 270, fund 100 then uses such excess assets as each payment in the stream of payments is to be paid to the investors according to the targeted payment schedule.

As fund 100 operates and encounters expected and/or unexpected expenses or costs that would reduce the actual stream of payments to investors to be below the scheduled stream of payments, fund 100 uses the excess assets to help absorb those expenses or costs. The unused portion of the excess assets is reflected in the net assets of fund 100 and is owned proportionately by each investor in fund 100. An investor would receive his share of any unused portion of the excess assets when fund 100 makes its final payment upon reaching its liquidation date, or earlier if the investor redeems his investment. An investor could also receive his share of any unused excess assets if the investment fund makes an unscheduled distribution prior to the liquidation date of the investment fund.

With regard to any capital gains generated by fund 100, the distribution or reinvestment of such capital gains may differ according to whether an investor holds conventional shares 120 or exchange-traded shares 130. For investors holding conventional shares 120, fund 100 may require that any capital gains generated by fund 100 be reinvested into fund 100. For investors holding exchange-traded shares 130, fund 100 may require that any capital gains generated by fund 100 be paid in cash to the shareholder of record (i.e., the broker, as described above) according to methods known in the art.

It will be appreciated that in the exemplary embodiment in which fund 100 is an open-end fund, at the end of each trading day, fund 100 may compute its NAV according to methods known in the art. Fund 100's NAV may fluctuate over the life of fund 100 as the value of underlying securities 110 might change because of interest rate volatility, particularly in the early years of a longer-lived fund 100. Furthermore, because portions of the payments made to investors comprise return of principal (or return of capital) portions, fund 100 is a so-called “wasting” asset, and the NAV of fund 100 trends downward as principal is returned. Fund 100's NAV, therefore, approaches zero at the scheduled liquidation date of the fund. In an exemplary embodiment, fund 100 includes a step 275 in which fund 100 periodically provides a statement to each of the investors in fund 100. Such a statement may provide various statistics about each investor's shares, such as the targeted payment amounts, actual payment amounts, the NAV of the shares on a specified date, the percentage of the shareholder's original principal (capital) that has been returned to the shareholder, etc.

Shareholders who continue to own shares 120 until the liquidation date of fund 100 are unaffected by the fluctuation in the NAV of fund 100 because the targeted payment schedule is unaffected by the NAV. Additionally, because a portion of each payment of fund 100 derives from return of capital, fund 100 provides larger cash flows than a similarly priced share in an income-oriented fund. Thus, it will be appreciated that fund 100 provides advantages over the traditional income-oriented mutual fund.

It will also be appreciated that fund 100 provides investors a liquid investment vehicle. As described above, conventional shares 120 in fund 100 may be redeemed to fund 100 at step 280 and exchange-traded shares 130 may be sold on a secondary market at any time, as is understood in the art. The investor is not locked into any period, as in the case of an annuity contract. If the investor runs into difficult financial times, unexpected expenses, or for any reason, he may redeem all or part of his shares 120 at NAV and/or sell all or part of his shares 130. (However, the redemption of shares 120 in fund 100, or the sale of shares 130, could result in the realization of a loss (or gain) by the investor.) Additionally, if the investor dies prior to the liquidation date of fund 100, he may bequeath his shares to others. Further, because shares 120 and 130 of fund 100 are the personal property of the investor, such shares can be transferred (i.e., gifted) to others, unlike a traditional annuity contract. Thus, it will be appreciated that fund 100 provides advantages over the traditional annuity contract.

At step 290, which is performed at the liquidation date, any remaining securities in pool of underlying securities 110 are liquidated and proportionally provided to investors in fund 100. In the event fund 100 offers exchange-traded shares 130, then at or near the liquidation date of fund 100, such exchange-traded shares 130 are de-listed from the exchange or exchanges on which they are listed in order to accommodate an orderly liquidation of fund 100.

Fund 100 also provides tax advantages. Under current tax laws and rules in place at the time the present application was filed, shares in mutual funds benefit from favorable estate tax treatment. Under these provisions, open end mutual is fund shares are eligible for a basis adjustment upon the death of the investor under current law. If the investments have appreciated during the investor's lifetime, the beneficiaries will inherit them with an income tax basis that is “stepped up” to then fair market value. And, when the investment is sold or exchanged by the beneficiary, the beneficiary will owe capital gains tax only on the appreciation during the time the beneficiary owned the investment—not on the growth during the original investor's lifetime. Thus, heirs and devisees who receive mutual fund shares from the decedent enjoy a stepped up cost basis for such shares; heirs and devisees receiving annuity contracts do not enjoy this same beneficial tax treatment.

### EXAMPLES

In a first example of the investment fund described above, fund 100 is created to be a 5-year open-end mutual fund that offers one class of shares and that invests solely in Treasury STRIPs. The NAV of such shares is to be calculated once per day at the close of trading. Fund 100 decides that each share will cost $100, with a target of having 1% or less of total assets as so-called excess assets, and with an expense ratio of 0.25%. The targeted payment schedule for each share of fund 100 is established to make yearly payments for the life of fund 100. Each payment is to increase by 3% year to year. Based on Treasury STRIPs that are presently available for purchase and that mature in Years 1 through 5, fund 100 establishes that $20.551 per share is to be provided to each shareholder in Year 1 (“Y1”), $21.168 per share in Year 2 (“Y2”), $21.803 per share in Year 3 (“Y3”), $22.457 per share in Year 4 (“Y4”), and $23.131 per share in Year 5 (“Y5”). Payments are to be made on the first business day of each calendar year.

In Year 0, fund 100 receives a purchase request for 1,000 shares and invests the $100,000 (less applicable costs, fees and expenses) in Treasury STRIPs which mature in each of Years 1 through 5. Fund 100 chooses the Treasury STRIPs to achieve the targeted payment schedule for each of the 1,000 shares in the purchase request, but fund 100 purchases slightly more Treasury STRIPs than necessary, for the specific purpose of having excess assets. Fund 100 issues the 1,000 shares to the requesting purchaser (shareholder or investor).

FIG. 3A illustrates the cash flows that the shareholder expects to receive over the life of fund 100. The initial $100,000 negative cash flow represents the is amount the shareholder paid for the 1,000 shares. The remaining positive cash flows compose the stream of payments that fund 100 expects to pay according to the targeted payment schedule. Because Treasury STRIPs are backed by the full faith and credit of the United States, and because the cash flows from the securities have been mapped to the predicted stream of payments, there is a high statistical probability that fund 100 will pay according to the targeted payment schedule.

FIG. 3B illustrates the cash flows that are expected to be provided by the maturing Treasury STRIPs to fund 100 in Years 1 through 5. Also illustrated in FIG. 3B are the expected cash flows to the shareholder. As is evident in FIG. 3B, in each year, the cash flows provided by the maturing Treasury STRIPs are expected to exceed the payments to the shareholder because fund 100 slightly over-funds its cash flow needs. The difference is to be held as excess assets and used to cover various expected or unexpected expenses. As illustrated in FIG. 3B, fund 100 expects to over fund its expense needs by $265, a proportional share of which is expected to be returned to the shareholder when fund 100 liquidates (or earlier if the shareholder redeems his shares or if fund 100 makes an unscheduled distribution).

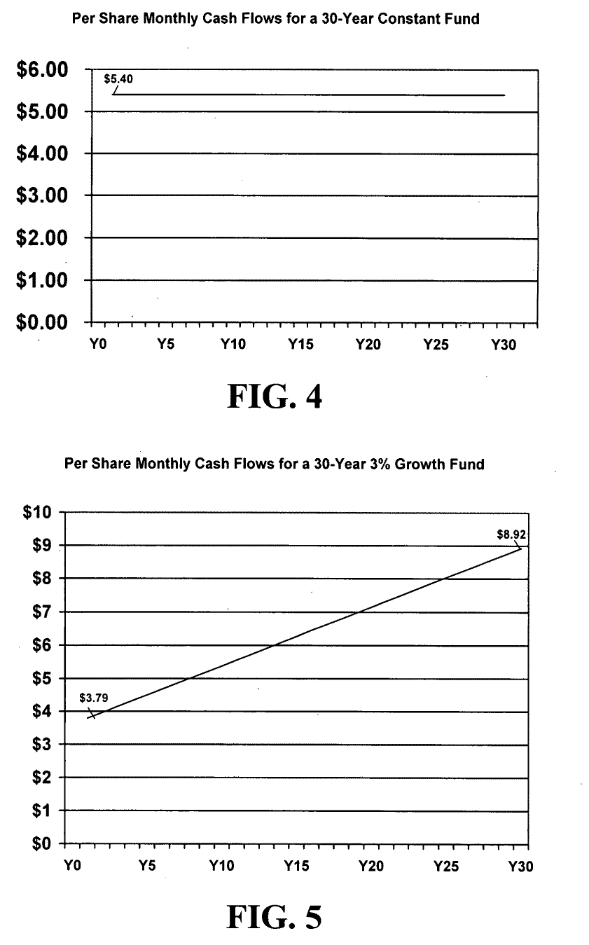

In another example of the investment fund described above, fund 100 is created to be a 30-year open-end mutual fund that offers one class of shares and that invests in Treasury bonds. The NAV of such shares is to be calculated once per day at the close of trading. Fund 100 decides that each share will cost $1,000, with a target of having 1% of total assets as so-called excess assets, and with an expense ratio of 0.25%. Fund 100 establishes that the targeted payment schedule will provide payments on a monthly basis for the life of fund 100. All payment amounts are to be the same. Based on Treasury bonds that are presently available in the bond market, fund 100 establishes that $5.40 per share is to be provided to each shareholder every month until fund 100 liquidates in Year 30. FIG. 4 illustrates the monthly cash flows that a shareholder may expect per each share over the life of fund 100.

Fund 100 invests its received capital in Treasury bonds that in aggregate provide interest payments and principal payments to achieve the targeted payment schedule. The Treasury bonds, therefore, constitute underlying securities 110. Based on the targeted payment schedule, fund 100 structures its investment in underlying securities 110 such that the portion of the payments to each shareholder, which portion derives from the yield of the Treasury bonds, is nearly 100% early on in the life of fund 100, but declines toward 0% over the 30-year life of fund 100. Correspondingly, the portion of the payments to each shareholder attributable to return of capital payments increases over the life of fund 100. At the early stages of the targeted payment schedule, most of cash flow to the shareholder is based on yield generated to fund 100 by underlying securities 110. Later, more of the cash flow is based on the return of capital. It will be appreciated that at fund 100's liquidation date, the NAV of fund 100 will be zero as all capital, including all excess assets, will have been returned.

In yet another example of the investment fund described above, fund 100 is created to be a 30-year open-end mutual fund that offers one class of shares and that invests in corporate bonds. The NAV of such shares is to be calculated once per day at the close of trading. Fund 100 establishes the targeted payment schedule for each share to make monthly payments for the life of fund 100. The targeted payment schedule is structured such that the payments increase month to month to provide a year-to-year increase of 3%. The first monthly payment is $3.79 per share and the last monthly payment is $8.92 per share. The shares are offered at $1,000 per share. FIG. 5 illustrates the monthly cash flows that a shareholder may expect per each share over the life of fund 100. As with the previous example, at early times in the targeted payout schedule, most of the cash flow to the shareholder is based on the yield generated to fund 100 by underlying securities 110. Later, more of the cash flow is based on the return of capital. It will be appreciated that at the liquidation date of fund 100, the NAV of fund 100 will be zero as all capital and excess assets will have been returned. (In the event that fund 100 were to invest in underlying securities 110 that are total return swaps or other investments that are linked to a hypothetical portfolio of corporate bonds, then payments from such securities 110 to fund 100 would still be characterized as principal or income payments.)

It should be understood that some or all of the method steps of this invention may be carried out by or with the assistance of a computer, including but not limited to automated processes for issuing, buying, and selling of shares and underlying securities, receiving and transmitting transfers to and from financial institutions for the purchase or shares or the distribution of periodic payments to shareholders, computerized accounting, computerized receipt and storage of shareholder data, computerized reporting to shareholders, and the like. It should also is be understood that the programming techniques necessary to automate such steps by computer are well known in the art.

While preferred embodiments and examples of the invention have been shown and described herein, it will be understood that such embodiments and examples are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A method of administering an investment fund comprising a scheduled liquidation date, the method comprising the steps of:
(a) creating one or more classes of shares;
(b) offering a plurality of shares for sale in each of the one or more classes of shares on a continuous basis from a time when the plurality of shares are first offered for sale until the scheduled liquidation date of the investment fund;
(c) determining a targeted payment schedule by a computer programmed to determine the targeted payment schedule, the targeted payment schedule specifying payments to be made by the investment fund per each share in the one or more classes of shares until the scheduled liquidation date, the targeted payment schedule providing for a recurring predetermined time interval between the payments;
(d) issuing at least one share to an investor in exchange for funds received from the investor;
(e) investing the received funds in one or more securities that provide scheduled payments that map to the payments specified by the targeted payment schedule corresponding to the at least one share; and
(f) providing payments to the investor according to the targeted payment schedule corresponding to the at least one share, wherein a first payment is provided within two predetermined time intervals after the at least one share is issued.

2. The method of claim 1, further comprising the steps of:
(g) at any time prior to the scheduled liquidation date of the investment fund, receiving one or more redemption requests from investors holding shares; and
(h) redeeming each share reflected in the one or more redemption requests at a net asset value.

3. The method of claim 1, wherein:
the funds received in step (d) comprise cash, and
the step of investing in step (e) comprises purchasing the one or more securities using the cash received in step (d).

4. The method of claim 1, wherein:
the funds received in step (d) comprise one or more securities, and
the step of investing in step (e) comprises placing the one or more securities received in step (d) into a pool of securities, thereby effecting an in-kind exchange.

5. The method of claim 1, wherein the payments specified by the targeted payment schedule are determined in step (c) to be provided on a periodic basis.

6. The method of claim 5, wherein the periodic basis is monthly or bi-monthly.

7. The method of claim 1, wherein the payments specified by the targeted payment schedule are determined in step (c) to be constant at a scheduled amount until the scheduled liquidation date of the investment fund.

8. The method of claim 1, wherein the payments specified by the targeted payment schedule are determined in step (c) based upon a schedule, methodology, or formula that meets a cash flow need or expectation of a group or segment of investors.

9. The method of claim 1, wherein the payments specified by the targeted payment schedule are determined in step (c) to increase by a fixed percentage from payment to payment until the scheduled liquidation date of the investment fund.

10. The method of claim 1, wherein the payments specified by the targeted payment schedule are determined in step (c) to increase by a variable percentage from payment to payment until the scheduled liquidation date of the investment fund, the variable percentage being based on a floating rate.

11. The method of claim 1, wherein the payments specified by the targeted payment schedule are determined in step (c) to be tied to a consumer price index until the scheduled liquidation date of the investment fund.

12. The method of claim 1, wherein at least one of the one or more classes of shares comprises conventional shares.

13. The method of claim 1, wherein at least one of the one or more classes of shares comprises exchange-traded shares.

14. The method of claim 1, wherein:
the one or more securities comprise one or more debt securities,
the scheduled payments of the one or more debt securities comprise (i) interest or coupon payments and (ii) principal or maturity payments, and
each of the payments provided to the investor in step (f) includes a portion derived from the interest or coupon payments of the one or more debt securities and a portion derived from the principal or maturity payments of the one or more debt securities.

15. The method of claim 14, wherein the portion derived from the principal or maturity payments of the one or more debt securities increases, from payment to payment, relative to the portion derived from the interest or coupon payments of the one or more debt securities.

16. The method of claim 1, wherein the one or more securities are selected in step (e) such that their scheduled payments are an excess amount greater than the payments specified by the targeted payment schedule corresponding to the at least one share, wherein the excess amount is used to cover costs or expenses of the investment fund, the method further comprising the step of:
(g) at the scheduled liquidation date of the investment fund, liquidating any remaining securities held by the investment fund and providing any proceeds to investors holding shares.

17. The method of claim 14, wherein the one or more debt securities comprise at least one of Treasury bills; Treasury notes; Treasury bonds; inflation protected securities such as Treasury Inflation-Protected Securities; Treasury STRIPs; corporate debt securities; municipal bonds; mortgage-backed securities; asset-backed securities; collateralized debt obligations; collateralized loan obligations; and interests in bank loans.

18. The method of claim 14, wherein each of the one or more debt securities in the pool of securities has a maturity date, and the interest or coupon payments and the principal or maturity payments made by each debt security are made at its maturity date, and the step (e) comprises selecting the one or more debt securities so that the interest or coupon payments and the principal or maturity payments made by each debt security at its maturity date map to the payments specified by the targeted payment schedule corresponding to the at least one share.

19. The method of claim 5, wherein the periodic basis is weekly, biweekly, quarterly, semi-annually, annually or biennially.

20. The method of claim 1, wherein the one or more securities comprise derivatives including at least one of: futures contracts, credit-default swaps, interest rate swaps, and total return swaps.

21. The method of claim 1, wherein the investment fund comprises an open-end investment fund.

22. The method of claim 1, wherein the investment fund comprises any of a common trust fund, a collective trust fund, a comingled trust fund, or a unit investment trust.

23. A method of administering an open-end investment company comprising one or more classes of shares and a scheduled liquidation date, the method comprising:
(a) offering a plurality of shares in any of the one or more classes of shares for sale on a continuous basis from a time when the plurality of shares are first offered for sale until the scheduled liquidation date of the investment company;
(b) determining a targeted payment schedule by a computer programmed to determine the targeted payment schedule, the targeted payment schedule specifying payments to be made by the investment company per each share of the plurality of shares until the scheduled liquidation date;
(c) issuing at least one share to an investor in exchange for funds received from the investor;
(d) investing the received funds in one or more securities that provide scheduled payments that map to the payments specified by the targeted payment schedule corresponding to the at least one share; and
(e) providing payments to the investor according to the targeted payment schedule corresponding to the at least one share.

24. The method of claim 23, wherein the one or more securities comprise one or more debt securities that provide (i) income or coupon payments and (ii) principal or maturity payments, and
step (d) comprises selectively investing the received funds in the one or more debt securities so that the income or coupon payments and the principal or maturity payments provided by the one or more debt securities map to the targeted payment schedule corresponding to the at least one share issued to the investor.

25. The method of claim 23, wherein the targeted payment schedule corresponding to the at least one share issued to the investor provides for periodic payments to be made beginning after the issuing of the at least one share and continuing until the scheduled liquidation date.

26. The method of claim 23, wherein the targeted payment schedule corresponding to the at least one share issued to the investor provides for periodic payments to be made beginning after the issuing of the at least one share and continuing until the scheduled liquidation date.

27. The method of claim 23, wherein the targeted payment schedule corresponding to the at least one share issued to the investor provides for recurring payments to be made to the investor with a predetermined time interval between payments, and a first payment to the investor is scheduled to be made within two predetermined time intervals after the issuing of the at least one share to the investor.

28. The method of claim 26, wherein the periodic payments are made monthly or bi-monthly.

29. The method of claim 28, wherein a first payment provided by the targeted payment schedule is made within two months after issuing the at least one share to the investor.

30. The method of claim 23, wherein the targeted payment schedule corresponding to the at least one share issued to the investor comprises periodic payments that have a value based upon a corresponding value of a predetermined variable at a predetermined time relative to when each payment is made to the investor.

31. The method of claim 23, wherein the one or more classes of shares include one or more classes of conventional shares.

32. The method of claim 23, wherein the one or more classes of shares include one or more classes of exchange-traded shares.

33. The method of claim 23, wherein the one or more classes of shares include one or more classes of conventional shares and one or more classes of exchange-traded shares.

34. The method of claim 23, further comprising the steps of:
(g) at any time prior to the liquidation date of the investment fund, receiving one or more redemption requests from one or more investors holding one or more shares; and
(h) redeeming each share reflected in the one or more redemption requests at a net asset value.

35. A method of administering any of a common trust fund, a collective trust fund, or a comingled trust fund comprising a scheduled liquidation date, the method comprising the steps of:
(a) offering a plurality of shares for sale on a continuous basis from a time when the plurality of shares are first offered for sale until the scheduled liquidation date;
(b) determining a targeted payment schedule by a computer programmed to determine the targeted payment schedule, the targeted payment schedule specifying payments to be made per each of the plurality of shares until the scheduled liquidation date;
(c) issuing at least one share to an investor in exchange for funds received from the investor;
(d) investing the received funds in one or more securities that provide scheduled payments that map to the payments specified by the targeted payment schedule corresponding to the at least one share issued; and
(e) providing payments to the investor according to the targeted payment schedule corresponding to the at least one share.

36. The method of claim 35, wherein the targeted payment schedule provides for payments to be made to the investor with a recurring predetermined time interval between payments, and a first payment is scheduled to be made to the investor within two predetermined time intervals after the at least one share is issued.

37. The method of claim 35, further comprising the steps of:
(f) at any time prior to the scheduled liquidation date, receiving one or more redemption requests from one or more investors holding one or more shares; and
(g) redeeming each share reflected in the one or more redemption requests at a net asset value.

38. The method of claim 35, wherein the targeted payment schedule comprises periodic payments of scheduled values.

39. The method of claim 35, wherein the targeted payment schedule comprises periodic payments of scheduled values.

40. A method of administering a unit investment trust comprising a scheduled liquidation date, the method comprising the steps of:
(a) offering a plurality of units for sale on a continuous basis from a time when the plurality of units are first offered for sale until the scheduled liquidation date;
(b) determining a targeted payment schedule by a computer programmed to determine the targeted payment schedule, the targeted payment schedule specifying payments to be made by the unit investment trust per each of the plurality of units until the scheduled liquidation date, the targeted payment schedule providing for a recurring predetermined time interval between payments;
(c) issuing at least one unit of the unit investment trust to an investor in exchange for funds received from the investor;
(d) investing the received funds in one or more securities that provide scheduled payments that map to the payments specified by the targeted payment schedule corresponding to the at least one unit; and
(e) providing payments to the investor according to the targeted payment schedule corresponding to the at least one unit, wherein a first payment is provided within two predetermined time intervals after the at least one unit is issued.

41. The method of claim 40, further comprising the steps of:
(f) at any time prior to the scheduled liquidation date of the unit investment trust, receiving one or more redemption requests from investors holding units; and
(g) redeeming each unit reflected in the one or more redemption requests at a net asset value.

42. The method of claim 40, wherein the targeted payment schedule corresponding to the at least one unit provides for periodic payments of scheduled values to be made beginning after the issuing of the at least one unit and continuing until the scheduled liquidation date.
